(19) United States
(12) Patent Application Publication
(10) Pub. No.: US 2025/0375746 A1
(43) Pub. Date: Dec. 11, 2025

(54) PATTERNING WETTABILITY IN COMPLEX MICROFLUIDIC CHANNELS FOR VERY LARGE-SCALE GENERATION OF DOUBLE EMULSIONS

(71) Applicant: THE TRUSTEES OF THE UNIVERSITY OF PENNSYLVANIA, Philadelphia, PA (US)

(72) Inventors: David Aaron ISSADORE, Philadelphia, PA (US); Daeyeon LEE, Wynnewood, PA (US); Jingyu WU, Philadelphia, PA (US)

(21) Appl. No.: 18/877,521

(22) PCT Filed: Jun. 16, 2023
(86) PCT No.: PCT/US2023/068584

§ 371 Date: Dec. 20, 2024

Related U.S. Application Data
(60) Provisional application No. 63/355,049, filed on Jun. 23, 2022.
(60) Provisional application No. 63/368,083, filed on Jul. 11, 2022.

(51) Int. Cl. B01F 33/30; B01F 23/41; B01F 35/00; B01L 3/00; C08F 22/10; C08G 65/22

(52) U.S. Cl. CPC B01F 33/30351; B01F 23/4105; B01F 23/4143; B01F 23/4144; B01F 23/4145; B01F 35/165; B01L 3/502761; C08F 22/1006; C08G 65/226; B01L 2200/0652; B01L 2200/0673; B01L 2300/165

(57) ABSTRACT

A method, comprising: providing a substrate having present thereon a pattern of hydrophobic and hydrophilic regions; contacting a polymerizable composition to the substate so as to confer the pattern of hydrophobic and hydrophilic regions onto the polymerizable composition; and polymerizing the polymerizable composition. A device, comprising a polymeric substrate, the poly-meric substrate having disposed thereon pattern of hydrophobic and hydrophilic regions, the polymeric substrate comprising a first component that is comparatively hydrophobic relative to a second component of the composition, and a hydrophobic region of the polymeric substrate being comparatively rich in the first component relative to the second component. A method, comprising using a microfluidic device according to the present disclosure to form an emulsion.

### CROSS-REFERENCE TO RELATED APPLICATIONS

The present application claims priority to and the benefit of U.S. patent application No. 63/355,049, “Patterning Wettability In Complex Microfluidic Channels For Very Large-Scale Generation Of Double Emulsions” (filed Jun. 23, 2022) and to U.S. patent application No. 63/368,083, “Patterning Wettability In Complex Microfluidic Channels For Very Large-Scale Generation Of Double Emulsions” (filed Jul. 11, 2023). All foregoing applications are incorporated herein by reference in their entireties for any and all purposes.

### GOVERNMENT RIGHTS

This invention was made with government support under HG010023 awarded by the National Institutes of Health. The government has certain rights in the invention.

### TECHNICAL FIELD

The present disclosure relates to the field of microfluidics.

### BACKGROUND

Spatially controlling the wetting properties of microfluidic channels is critical for the controlled and stable formation of multi-order emulsions, for example, double emulsions. Existing patterning methods, which rely on selectively delivering fluid to particular regions of the chip, suffer from low spatial resolution, scalability, and cumbersome procedures. These challenges make it difficult to reliably produce chips to generate multi-order emulsions, and impossible to translate these techniques to parallelized chips that contain many devices on a single chip. Accordingly, there is a long-felt need in the art for improved patterning methods.

### SUMMARY

Here is described present a method to pattern the wettability in highly parallelized microfluidic chips with micrometer resolution. The disclosed patterning strategy takes advantage of the robust photolithography process and uses a silane chemistry compatible with the harsh chemical and temperature environments inherent to wafer-level micro-fabrication.

We first demonstrate this approach on exemplary, non-limiting single-channel silicon-and-glass devices, forming both W/O/W and O/W/O emulsions. The technique is extended to pattern wetting properties in a 2100-channel parallelized double emulsion chip, enabling the production of double emulsions at an industrial-relevant scale. We also show that this patterning strategy can be leveraged to pattern wettability in polymer-based microfluidic devices. Moreover, using a PFPE (perfluoropolyether)-PEGDA (poly (ethylene glycol) diacrylate) polymer mixture, we show that the microscale wettability pattern in the Si wafer can be transferred to a polymer device replicate, enabling a one-step patterning of a polymeric device. The alteration of the polymer surface properties is verified by contact angle measurements, vapor condensation experiments, and time-of-flight secondary ion mass spectroscopy. We demonstrate the generation of double emulsion with patterned polymer devices as well. Although the example data relate to patterning wettability for droplet generation in microfluidics, the method can be used to pattern surface functionalities in complex microfluidic devices for separation of multiphase flow systems, biological cell patterning and wall-free flow control, and the like.

The present disclosure provides, for example, a method of forming a component having a wettability pattern, comprising: providing a substrate having present thereon a pattern of hydrophobic and hydrophilic regions; contacting a polymerizable composition to the substate so as to confer the pattern of hydrophobic and hydrophilic regions onto the polymerizable composition; and polymerizing the polymerizable composition.

Also provided is a microfluidic device, the microfluidic device comprising a polymeric substrate, the polymeric substrate having disposed thereon pattern of hydrophobic and hydrophilic regions, the polymeric substrate comprising a first component that is comparatively hydrophobic relative to a second component of the composition, and a hydrophobic region of the polymeric substrate being comparatively rich in the first component relative to the second component.

Further provided is a method, comprising using a microfluidic device according to the present disclosure to form an emulsion.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIGS. 1A-1C provide (FIG. 1A) an illustration of a non-limiting process according to the present disclosure, (FIG. 1B) an example hydrophobic macromonomer (PFPE-DA) and an example hydrophilic macromonomer (PEG-DA), and (FIG. 1C) an example wetting pattern achieved by the disclosed technology.

FIGS. 2A-2C provide (FIG. 2A) the contact angle of a water droplet in hexane on (i) a hydrophobically-modified Si substrate and (ii) an unmodified Si substrate, (FIG. 2B) the contact angle of a water droplet in hexane on treated and untreated Si substrates, and (FIG. 2C) the contact angle of a water droplet in hexane on a given mold following several cycles of wettability pattern transfer.

FIGS. 3A-3B provide (FIG. 3A) a depiction of hydrophobic lines of various widths on a silicon wafer and (FIG. 3B) the pattern of vapor condensation on a silicon wafer having a hydrophobic pattern formed thereon that corresponds to the pattern in FIG. 3A.

FIGS. 4A-4C provide an illustration of the disclosed technology.

FIGS. 5A-5D provide illustrations of the disclosed technology.

FIG. 6 provides an illustration of the disclosed technology, showing (left) placement of a PEGDA-PFPE mixture on a patterned wafer, (top) illustration of hydrophobic pattern lines of various widths, and (bottom) microscopic images of droplets on the patterned areas, showing the presence of the droplets in conformity with the pattern.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Surface wetting properties are crucial to the performance of microfluidic devices and spatially patterned hydrophobic/hydrophilic microchannels have found various applications¹⁻⁵. Notably, the generation of higher-order emulsions require specific regions to have pre-defined wettability such that the desired fluid phases flow in contact with the surface of the microchannels⁶.

One type of method is to assemble pre-modified components together, for example the co-axially assembled capillary devices⁷. While the surface modification is relatively straightforward, the fabrication of glass capillaries limited the channel resolution and scalability of the device.

For lithographically fabricated polymer devices, multiple strategies have been developed to spatially modify the surface properties; these include sequentially flowing chemicals into the microfluidic channels while blocking the unwanted regions^{6,8,9} or flowing plasma into the channels for a controlled amount of time¹⁰. These methods often require multistep operation with limited spatial resolution, making it impractical to modify devices in large quantity.

Recently, perfluoropolyether (PFPE)-based polymer is useful in fabrication of microfluidic device, as its wettability can be modulated by mixing with hydrophilic macromonomer, Poly-ethylene Glycol Diacrylate (PEGDA)^{11,12}. The hydrophilicity of the polymer mixture increases with the concentration of the PEGDA in the network. However, the wettability of such network remains the same throughout the entire microfluidic device since PEGDA is uniformly distributed in PFPE. One way to expand the applicability of such device is to spatially pattern the wettability of the device, and—without being bound to any particular theory—it was hypothesized that one could achieve a high spatial resolution patterning by enriching the PFPE near the surface of the network, by transferring the patterning from the substrate that is used to prepare the network. Instead of chemically modifying the channel surface of the polymer device, described here is a novel approach that directly pattern the wettability of the mold, which induces wettability change near the network surface, and hence, the wetting properties. This approach allows rapid device fabrication, combining the device curing and surface patterning at the same time.

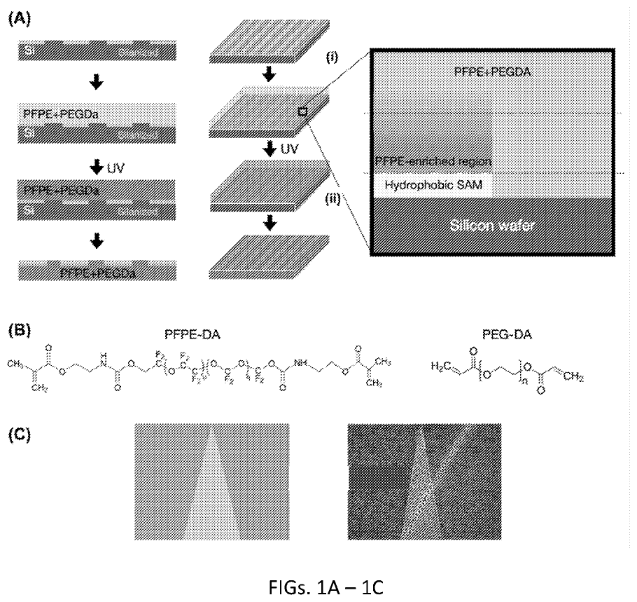

In this work, we present the wettability transfer from a patterned surface to a PFPE-PEG network that is composed of 10 wt % PEGDA in PFPE (FIG. 1A, B). The molding substrate is a 4-inch silicon wafer that contains microchannels fabricated using conventional photolithography and dry etching techniques. The patterning of wettability on the substrate again uses photolithography and silane chemistry to define hydrophobic/hydrophilic regions with micrometer resolution (FIG. 1C). The wettability transfer can be readily achieved by UV-curing of PFPE-PEG prepolymer mixture that is in contact with patterned silicon substrate. We verified the wettability patterning through contact angle measurement and Time-of-flight secondary ion mass spectroscopy (TOF-SIMS). Using the patterned network as microfluidic device, we demonstrated the generation of double emulsion, which has found wide applications in functional material synthesis and biomedical researches¹³⁻¹⁵.

The example two-part polymer network described here to illustrate the disclosed technology included a hydrophobic macromonomer, PFPEDA (Perfluoroether-polyethylene Dimethacrylate), and hydrophilic macromonomer, PEGDA (Polyethylene glycol Diacrylate) (FIG. 1B). It should be understood, of course, that the polymer network (which can also be termed a polymer composition) can include a hydrophobic macromonomer different from PFPEDA and can also include a hydrophilic macromonomer other than PEGDA.

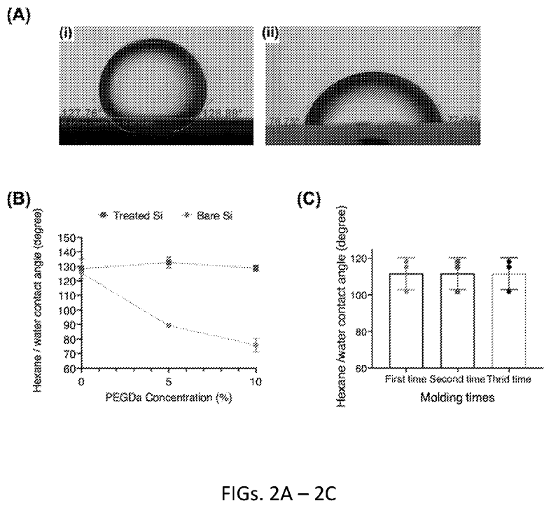

The polymer mixture with 4 wt % photoinitiator, 2-Hydroxy2-methylpropiophenone (Darocur 1173), crosslinks under UV irradiation. To test our hypothesis, the polymer mixture is cured with direct contact with two separate pieces of silicon wafers. One wafer is in its native condition while the other's surface is hydrophobically modified using 1 v/v % of Trichloro (1H,1H,2H,2H-perfluorooctyl) silane in HFE-7500 oil. The cured pieces of PFPE-PEG are peeled off from the silicon wafer, and water in hexane contact angle measurements are done on the side that were in contact with the silicon (FIG. 2A). For the network prepared on bare silicon wafer, increasing the PEGDA concentration from 0 to 10 wt % in the network would result in an increase of hydrophilicity, agreeing with our previously published results¹¹. Interestingly, the network prepared on silane-treated silicon remain hydrophobic regardless the PEGDA concentration (FIG. 2B). Without being bound to any particular theory or embodiment, these results shows that the hydrophobic silane coating enriches the polymer surface with PFPE monomers, which confers hydrophobic properties on the surface. We also demonstrate the reusability of this strategy by fabricating a polymer device repeatedly using the same substrate. After multiple molding times, the wettability was still transferred to the polymer network without compromising the surface properties (FIG. 2C) of the polymer network.

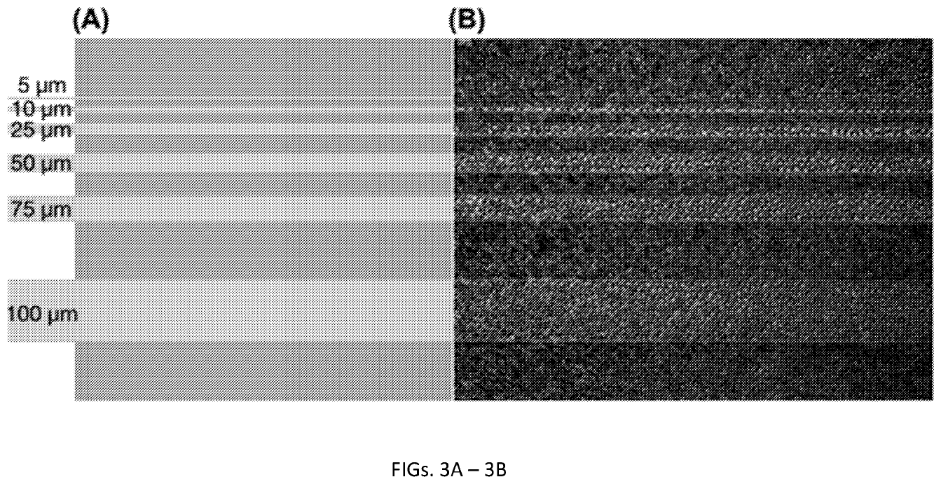

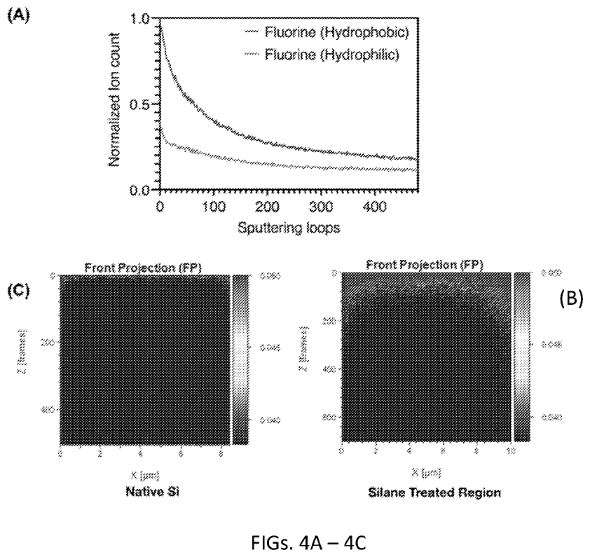

Wettability transfer with high spatial resolution was demonstrated through lithographically defined patterns. Example lines with different width, ranging from 5 μm to 100 μm were patterned using a standard photolithography process on a silicon wafer. (FIG. 3A). The patterned wafer was silane-treated using the approach described earlier such that the areas that have line patterns are comparatively hydrophobic while the rest of the wafer is hydrophilic. The PFPE-PEG network prepared from this substrate is tested with vapor condensation experiment for visualization of the wettability transfer. As shown in FIG. 3B, the vapor condenses on the surface of the network, forming bigger droplets on the hydrophobic line regions and smaller droplets on the other regions, as they are hydrophilic. The vapor test confirmed the success transfer of the wettability from the patterned substrate and demonstrated micrometer scale spatial resolution.

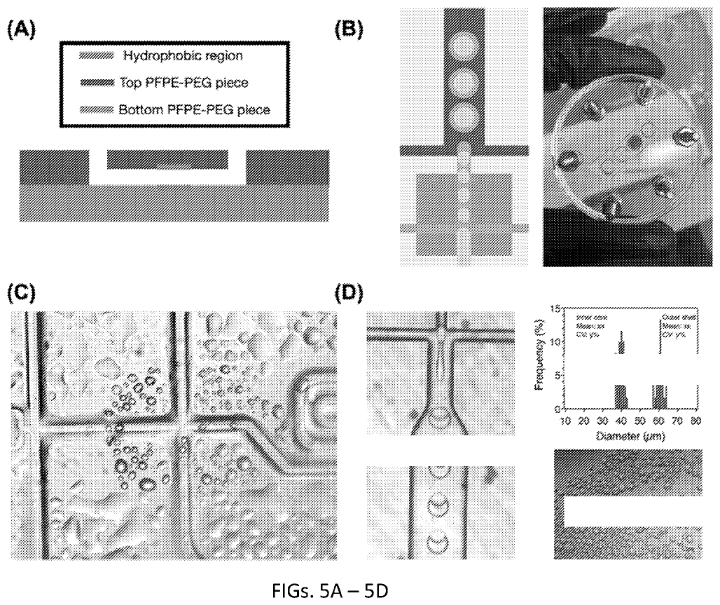

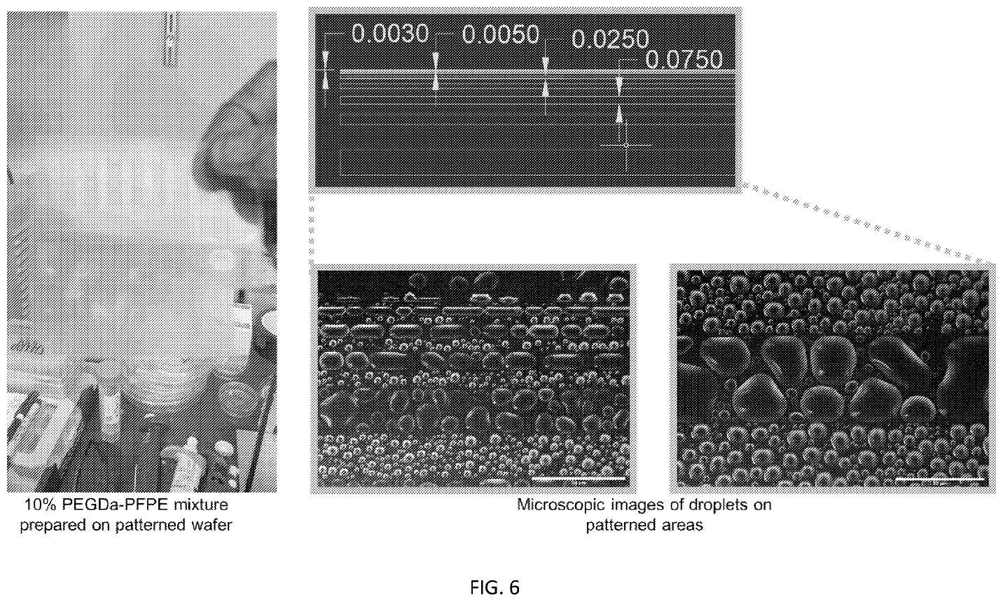

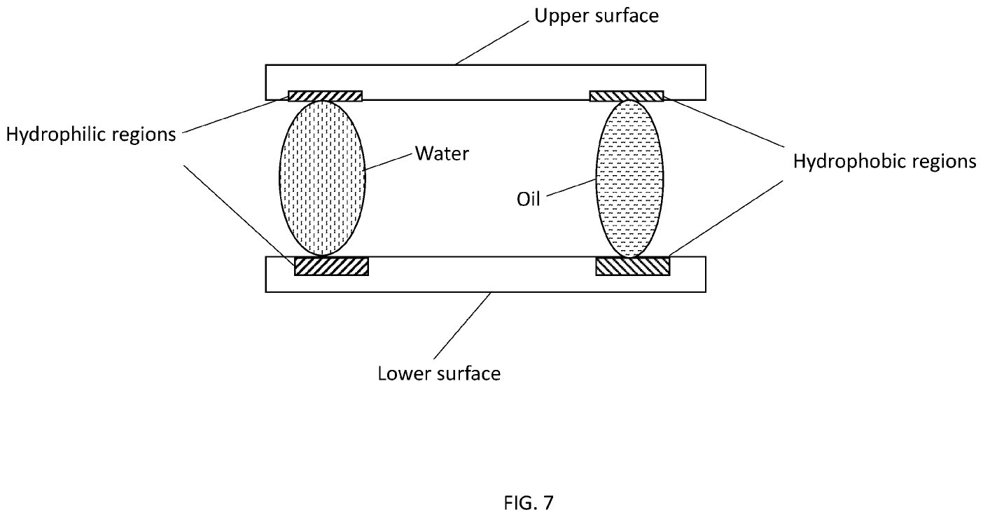

To further confirm our hypothesis, time-of-flight secondary mass spectrometry (TOF-SIMS) was performed on the PFPE-PEG network to investigate the chemical composition and distribution near the network surface. Ion beams are sputtered onto the surface of the thin film, removing the molecules from the outermost layer from the surface to be analyzed by the detector. The analysis is focused on fluorine since it exists in PFPE but not in PEGDA. Separate tests are performed on the hydrophilic region and hydrophobic region of the polymer network. The depth profiles show that the fluorine is enriched near the surface for the hydrophobic regions, indicating the enrichment of PFPE. In comparison, fluorine is not enriched for the hydrophilic region (FIG. 4A, B, C). The enrichment of the PFPE is a result from the electrostatic attraction between the silane and PFPE molecules and the repulsion between the silane and PEGDA molecules.

We evaluated our patterning strategy by fabricating a microfluidic device and generating double emulsions. The microfluidic device consists of two PFPE-PEG network pieces, with the top piece containing the microfluidic channels and a flat bottom part. Both parts are fabricated using replica molding from silane patterned silicon substrates (FIG. 5A, B). For W/O/W double emulsion generation, we rendered the region of the first nozzle to be hydrophobic for the generation of water in oil emulsion. The rest of device is hydrophilic by the nature of the PFPE-PEG network and is therefore suitable for an aqueous outermost fluid. Both top and bottom PFPE-PEG piece contains visible alignment marks such that they can be aligned manually by hand. The aligned pieces are encapsulated in a metal clamp, which temporarily seals the device during operation and allows the detachment of the two polymer pieces for the ease of cleaning and reuse. A vapor condensation test is done on the PFPE-PEG pieces and shows that the wetting property of the desired regions are successfully changed (FIG. 5C). We tested the device by flowing DI water with 2% PVA as the outer phase, HFE-7500 with 2% Krytox as the middle phase, and DI water with 1% Tween 20 as the inner phase (FIG. 5D). Example generated double emulsions are shown in (FIG. 5D).

Illustrative hard masters for molding microchannels in PFPE-PEG network were fabricated based on photolithography and dry etching techniques. Briefly, a silicon wafer is first dipped into 49% HF for 1 min to remove the native oxide layer; this increases the adhesion between the substrate and the photoresist. Then 4 μm of positive photoresist S1805 is spray coated using a spray coater (SUSS Tech AS8), followed by UV exposure using a mask aligner (SUSS MA6), with microchannel patterns. The developed wafer is then dried and etched using deep reactive ion etcher, creating channels with a depth of 60 μm. The etched wafer is cleaned sequentially with acetone, IPA, DI water, nanostrip, and DI water again. Then the wafer is dried and ready for further use.

To pattern the wettability of the silicon substrate, a standard photolithography process was performed. The silicon substrate that contains microchannels was first coated with 4 μm photoresist S1805 and then exposed using a mask aligner (SUSS MA6). After exposure and development, the substrate was rinsed by DI water and dried. The wafer was then submerged into a silane solution, which included 1v/v % of

Trichloro (1H, 1H,2H,2H-perfluorooctyl) silane (Millipore Sigma) in perfluorinated oil HFE-7500 (3M) for 10 mins, followed by a rinse of pure HFE 7500 oil to wash away unreacted silane. The wafer was then dried and baked on a hotplate at 65° C. for 30 mins.

A mixture of PFPE-PEGDA prepolymer was prepared by thoroughly mixing 10wt % PEGDA (Millipore Sigma) with PFPEDA (Fluorolink MD700, Solvay), and 4 wt % photoinitiator, Irgacure 2959 (Millipore Sigma). The mixture was poured onto the patterned silicon substrate and degassed in a vacuum chamber. A glass wafer (University wafer, ID 775) was placed on top of the prepolymer, and the sandwiched wafer stack is exposed under a flood UV (Skyray 800, Uvitron) for 5 mins at 50% intensity. After exposure, the cured polymer piece was peeled off from the substrate. The wettability transfer is confirmed by a vapor condensation test using a humidifier.

The patterned surface of the PFPE-PEG network was characterized using a Tensiometer (Attension), to measure the water droplet's contact angle. For each measurement, 50 μL of water was dispensed onto a substrate that is submerged in hexane. For each substrate, the measurement is repeated 5 times.

To form a W/O/W double emulsion, DI water with 1 wt % Tween 20 as surfactant is used as the inner phase. Fluorinated oil HFE-7500 (3M) with 2 wt % Krytox 157 FSH (Dupont) is used as the middle phase. For the outer phase, DI water with 1 wt % Tween 20 and 2 wt % Pluronic F68 is used. All three phases were loaded into syringes and driven into the device via syringe pumps (Harvard).

### Aspects

The following Aspects are illustrative only and do not limit the scope of the present disclosure or the appended claims. Any part or parts of any one or more Aspects can be combined with any part or parts of any one or more other Aspects.

Aspect 1. A method of forming a component having a wettability pattern, comprising:
providing a substrate having present thereon a pattern of hydrophobic and hydrophilic regions;

contacting a polymerizable composition to the substate so as to confer the pattern of hydrophobic and hydrophilic regions onto the polymerizable composition; and

polymerizing the polymerizable composition.

FIG. 1A provides a view of an example method. As shown, a user can silanize a Si substrate in a patterned fashion so as to confer onto the Si substrate a hydrophobic pattern corresponding to the silane pattern. The user can then contact a polymerizable composition that includes a comparatively hydrophobic component and a comparatively hydrophilic component—PFPE and PEGDA, respectively, in this non-limiting example—to the patterned substrate.

As shown, the presence of the silane on the substrate gives rise to corresponding regions within the polymerizable composition that are comparatively rich in the hydrophobic component of the polymerizable composition. The polymerizable composition can then be polymerized, thereby giving rise to a solid component that has formed thereon a pattern of hydrophobic and hydrophilic regions. The solid component can then be incorporated into a microfluidic device, for example, an emulsion maker or other device.

A first solid component as described herein having a hydrophobic pattern thereon can be assembled with a second such component (which can have the same hydrophobic pattern thereon as the first solid component, although this is not a requirement). Such an arrangement is provided in FIG. 5A, which figure shows a cross-section of a device formed of a top component and a bottom component, the top component and the bottom component having hydrophobic regions that face one another.

A pattern can include a feature, a line, for example, that has a cross-sectional dimension in the range of microns, tens of microns, or even hundreds of microns. For example, a pattern can include a line that has a width in the range of from about 1 μm to about 1000 μm, from about 2 μm to about 500 μm, from about 3 μm to about 400 μm, or from about 5 μm to about 300 μm, from about 6 μm to about 250 μm, from about 7 μm to about 200 μm, from about 8 μm to about 150 μm, or even from about 9 μm to about 125 μm, or from about 10 μm to about 100 μm, and all intermediate values, for example, from about 10 to about 100 μm, from about 20 to about 90 μm, from about 30 to about 80 μm, from about 40 μm to about 70 μm, or from about 50 to about 60 μm. A pattern can include, for example, lines, dots, chevrons, curves, ellipses, triangles, and the like. A pattern can be regular or periodic in nature, but this is not a requirement, as a pattern can be non-periodic in nature. The disclosed technology allows a user to pattern any desired wettability pattern.

The disclosed methods can include contacting successive polymerizable compositions to the same patterned substrate so as to transfer the wettability pattern of the substrate to the successive polymerizable compositions. For example, a user can place a first amount of a polymerizable composition, such as one that includes PFPE and PEGDA, onto a patterned substrate so as to give rise to a PFPE-rich region of the polymerizable composition and polymerize that first amount of the polymerizable composition to give rise to a first patterned workpiece. The user can then place a second amount of a polymerizable composition, such as one that includes PFPE and PEGDA, onto the patterned substrate so as to give rise to a PFPE-rich region of the polymerizable composition and polymerize that second amount of the polymerizable composition to give rise to a second patterned workpiece. The wettability pattern of the first workpiece can match the wettability pattern of the second workpiece, in configuration and/or in performance, thereby allowing a user to produce a number of workpieces having the same or similar wettability patterns, which production can be parallelized and performed at scale. The disclosed technology also allows for efficient changes to wettability patterns, as a user who desired to change the wettability pattern on the polymeric workpieces can simply change—for example, “swap out”—the patterned substrate that is used to “print” the wettability pattern of the polymeric workpieces and replace that patterned substrate with an alternative substrate having the newly-desired pattern.

Aspect 2. The method of Aspect 1, wherein the substrate comprises silicon. Other substrates can be used.

Aspect 3. The method of any one of Aspects 1-2, wherein the pattern of hydrophobic and hydrophilic regions comprises a silane. Example silanes can include perfluoro octyl silane (for example, trichloro (1H, 1H,2H,2H-perfluorooctyl) silane (PFOCTS)), perfluoro decyl silane, and perfluorooctyltriethoxysilane.

Aspect 4. The method of any one of Aspects 1-3, wherein the polymerizable composition comprises a first component that is comparatively hydrophobic relative to a second component of the composition. The first component can be, for example, an acrylic, an epoxy, polyethylene, polystyrene, polyvinylchloride, a polyester, or a perfluoropolymer; polytetrafluorethylenes, polydimethylsiloxanes, and polyurethanes can be used. PFPE can be used as the first component; PDMS can also be used as a first component.

The second component can be, for example, polyethylene glycol or a derivative thereof, such as polyethylene glycol diacrylate. Other exemplary second components include, for example, PEG-dextran and PDMS-PEG. The second component can, in some examples, be a polymer that includes a charged or polar functional group.

Aspect 5. The method of Aspect 4, wherein the contacting gives rise to a region of the polymerizable composition that is comparatively rich in the first component relative to the second component. The region can, in some cases, be comparatively thin, for example, in the range of nanometers, tens of nanometers, or hundreds of nanometers. The region can be microns—for example from about 1 to about 10 microns—in thickness in some cases. As shown herein, the region that is comparatively rich in the first component relative to the second component can extend from a surface of the composition into the composition.

Aspect 6. The method of any one of Aspects 1-5, wherein the polymerizable composition comprises a perfluoropolyether (PFPE).

Aspect 7. The method of any one of Aspects 1-6, wherein the polymerizable composition comprises polyethylene glycol diacrylate (PEGDA).

Aspect 8. A component, the component made according to any one of Aspects 1-7. Such a component can take the form of, for example, a portion of a microfluidic device.

Aspect 9. A microfluidic device, the microfluidic device comprising a polymeric substrate, the polymeric substrate having disposed thereon a pattern of hydrophobic and hydrophilic regions, the polymeric substrate comprising a first component that is comparatively hydrophobic relative to a second component of the polymeric substrate, and a hydrophobic region of the polymeric substrate being comparatively rich in the first component relative to the second component. A hydrophilic region of the substrate can be comparatively rich in the second component relative to the first component.

It should be understood that a polymeric substrate can include (i) a region or regions that are comparatively rich in the first component relative to the second component, (ii) a region or regions that are comparatively rich in the second component relative to the first component, and/or (iii) at least one region that is comparatively rich in the first component relative to the second component and at least one region that is comparatively rich in the second component relative to the first component.

A microfluidic device can include one or more channels. A channel can include one or more portions—which portions can be, for example, a ceiling, a floor, or a wall—that includes a pattern of hydrophobic material, for example, lines, chevrons, dots, and the like. A portion of the pattern of hydrophobic material can have a cross-sectional dimension-which can be, for example, a width—in the range of from about 1 to about 100 μm, or from about 2 to about 75 μm, or from about 5 to about 70 μm, or from about 6 to about 50 μm, and all intermediate values and sub-ranges.

A microfluidic device can include, for example, channels, vias, mixing regions, and the like. A microfluidic device can define, for example, a droplet generator or even a plurality of droplet generators, which droplet generators can be configured as emulsion generators. A device can include a plurality of droplet generators, for example, tens of droplet generators, hundreds of droplet makers, or even thousands of droplet makers.

A microfluidic device can include two or more portions bonded to one another, for example, an upper portion having a groove formed therein, a lower portion having a groove formed therein, with the upper and lower portions bonded together such that the grooves face one another and form a channel therebetween. This is not a requirement, however, as a microfluidic device can include a first portion having a groove formed therein and a portion that is flat—for example, example, configured as lid—and is bonded to the first portion.

Aspect 10. A method, the method comprising using a microfluidic device according to Aspect 9 to form an emulsion.

Aspect 11. The method of Aspect 10, wherein the emulsion is a double emulsion.

Aspect 12. The method of Aspect 11, wherein the double emulsion is a water-in-oil-in-water emulsion.

Aspect 13. The method of Aspect 11, wherein the double emulsion is an oil-in-water-in-oil emulsion.

Aspect 14. The method of Aspect 10, wherein the emulsion is a triple emulsion.

Aspect 15. A method, the method comprising using a microfluidic device according to Aspect 9 to invert an emulsion.

Aspect 16. The method of Aspect 15, wherein the emulsion comprises a hydrophobic phase within a hydrophilic phase.

Aspect 17. The method of Aspect 15, wherein the emulsion comprises a hydrophilic phase within a hydrophobic phase.

Aspect 18. The method of Aspect 15, wherein the method is performed so as to separate a multiphase sample.

Aspect 19. The method of Aspect 15, wherein the method is performed so as to effect cell patterning. Such cell patterning can, for example, be performed so as to direct cells to specific regions of a microfluidic device. The cell patterning can be performed, for example, to give rise to first regions on a surface on which cells are present and to second regions on the surface on which the cells are not present or are present at a lower density than on the first regions.

Devices according to the present disclosure can be used to separate cells, particles, or other components of a mixture on the basis of the components' relative hydrophobicity. By virtue of a device's hydrophobic patterning, a device can define virtual flow channels; such channels can be regions of comparatively high hydrophilicity disposed between regions of comparatively high hydrophobicity, and an aqueous material—such as water—will preferentially remain along the regions of comparatively high hydrophilicity. In this way, a user can define virtual channels on a device, which virtual channels can—based on their hydrophobic and hydrophilic character—preferentially carry aqueous and non-aqueous materials. As but one example, one can apply a mixture of aqueous and non-aqueous material, which mixture will respectively separate onto hydrophilic and hydrophobic regions of the device.

As but one example, a device can include an upper surface and a lower surface, the upper surface and lower surface facing one another. Either or both of the upper surface and lower surface can comprise hydrophilic regions and/or hydrophobic regions, and the hydrophilic regions and/or hydrophobic regions of one of the upper surface and the lower surface can optionally be in register with the hydrophilic regions and/or hydrophobic regions of the other of the upper surface and the lower. The hydrophilic regions and/or hydrophobic regions of the upper surface can lie in a first plane, and the hydrophilic regions and/or hydrophobic regions of the lower surface can lie in a second plane. Fluid can be present between the upper surface and the lower surface, and the location of that fluid—whether static or moving—can be constrained by the hydrophilic regions and/or hydrophobic regions of the upper surface and/or lower surface, rather than by physical walls or ridges extending from one or both of the upper surface and the lower surface. In this way, a device can include virtual fluidic elements—for example, channels, reservoirs, and the like—instead of or even in addition to walls, channels, and other structures that normally constrain fluid movement. As an example, a device can include an upper surface and a lower surface as described herein, with at least some hydrophobic and/or hydrophilic regions that are unbounded by physical walls, ridges, or other structures that normally constrain fluid movement. In this way, a user can construct microfluidic chips without the need—or with a reduced or minimal need—for additive manufacturing steps or subtractive manufacturing steps, such as etching.

An example device is shown in FIG. 7. As shown, a device can include an upper surface and a lower surface, and the upper surface and the lower surface can include regions of relative hydrophobicity and hydrophilicity, which regions can be in register with one another. As shown, an aqueous material will preferentially accumulate at the hydrophilic regions, which regions can define a virtual channel or reservoir for that aqueous material. A non-aqueous material, such as an oil, will preferentially accumulate at the hydrophobic regions, which regions can define a virtual channel or reservoir for that non-aqueous material. As shown, the aqueous and non-aqueous materials will be constrained by the hydrophobic and hydrophilic regions without the need for ridges or walls to otherwise constrain the materials. Although FIG. 7 illustrates hydrophobic and hydrophilic regions on the upper surface and the lower surface, it should be understood that a hydrophilic and/or hydrophobic region can be present on a wall that extends at least partway between the upper surface and the lower surface. As described elsewhere, devices and methods according to the present disclosure can be used to form, invert, or otherwise process emulsions.

Aspect 20. The method of Aspect 15, wherein the method is performed so as to redirect a fluid flow.

### REFERENCES

(1) Lourenço, B. N.; Marchioli, G.; Song, W.; Reis, R. L.; van Blitterswijk, C. A., Karperien, M.; van Apeldoorn, A.; Mano, J. F. Wettability Influences Cell Behavior on Superhydrophobic Surfaces with Different Topographies. Biointerphases 2012, 7 (1), 46. https://doi.org/10.1007/s13758-012-0046-6.
(2) Zhu, P.; Wang, L. Microfluidics-Enabled Soft Manufacture of Materials with Tailorable Wettability. Chem. Rev. 2022, 122 (7), 7010-7060. https://doi.org/10.1021/acs.chemrev.1c00530.
(3) Tan, J. L.; Liu, W.; Nelson, C. M.; Raghavan, S.; Chen, C. S. Simple Approach to Micropattern Cells on Common Culture Substrates by Tuning Substrate Wettability. Tissue Eng. 2004, 10 (5-6), 865-872. https://doi.org/10.1089/1076327041348365.
(4) Tsougeni, K.; Petrou, P. S.; Papageorgiou, D. P.; Kakabakos, S. E.; Tserepi, A.; Gogolides, E. Controlled Protein Adsorption on Microfluidic Channels with Engineered Roughness and Wettability. Sens. Actuators B Chem. 2012, 161 (1), 216-222. https://doi.org/10.1016/j.snb.2011.10.022.
(5) Kobayashi, T.; Shimizu, K.; Kaizuma, Y.; Konishi, S. Novel Combination of Hydrophilic/Hydrophobic Surface for Large Wettability Difference and Its Application to Liquid Manipulation. Lab. Chip 2011, 11 (4), 639-644. https://doi.org/10.1039/COLC00394H.
(6) Abate, A. R.; Weitz, D. A. High-Order Multiple Emulsions Formed in Poly (Dimethylsiloxane) Microfluidics. Small 2009, 5 (18), 2030-2032. https://doi.org/10.1002/smll.200900569.
(7) Utada, A. S. Monodisperse Double Emulsions Generated from a Microcapillary Device.
Science 2005, 308 (5721), 537-541. https://doi.org/10.1126/science.1109164.
(8) Abate, A. R.; Thiele, J.; Weinhart, M.; Weitz, D. A. Patterning Microfluidic Device Wettability Using Flow Confinement. Lab. Chip 2010, 10 (14), 1774-1776. https://doi.org/10.1039/C004124F.
(9) Bauer, W.-A. C.; Fischlechner, M.; Abell, C.; Huck, W. T. S. Hydrophilic PDMS Microchannels for High-Throughput Formation of Oil-in-Water Microdroplets and Water-in-Oil-in-Water Double Emulsions. Lab. Chip 2010, 10 (14), 1814-1819. https://doi.org/10.1039/C004046K.
(10) Kim, S. C.; Sukovich, D. J.; Abate, A. R. Patterning Microfluidic Device Wettability with Spatially-Controlled Plasma Oxidation. Lab. Chip 2015, 15 (15), 3163-3169. https://doi.org/10.1039/C5LC00626K.
(11) Jeong, H.-H.; Han, S. H.; Yadavali, S.; Kim, J.; Issadore, D.; Lee, D. Moldable Perfluoropolyether-Polyethylene Glycol Networks with Tunable Wettability and Solvent Resistance for Rapid Prototyping of Droplet Microfluidics. Chem. Mater. 2018, 30 (8), 2583-2588. https://doi.org/10.1021/acs.chemmater.7b05043.
(12) Zhu, F.; He, Y.; Lu, Z.; Fan, H.; Zhang, T. Composite Elastomer-Enabled Rapid Photofabrication of Microfluidic Devices. ACS Appl. Mater. Interfaces 2021. https://doi.org/10.1021/acsami.1c06143.
(13) Datta, S. S.; Abbaspourrad, A.; Amstad, E.; Fan, J.; Kim, S.-H.; Romanowsky, M.; Shum,
(14) Shah, R. K.; Shum, H. C.; Rowat, A. C.; Lee, D.; Agresti, J. J.; Utada, A. S.; Chu, L.-Y.; Kim, J.-W.; Fernandez-Nieves, A.; Martinez, C. J.; Weitz, D. A. Designer Emulsions Using Microfluidics. Mater. Today 2008, 11 (4), 18-27. https://doi.org/10.1016/S1369-7021 (08) 70053-1.
(15) Schroen, K.; Berton-Carabin, C.; Renard, D.; Marquis, M.; Boire, A.; Cochereau, R.; Amine, C.; Marze, S. Droplet Microfluidics for Food and Nutrition Applications. Micromachines 2021, 12 (8), 863. https://doi.org/10.3390/mi12080863.
H. C.; Sun, B.; Utada, A. S.; Windbergs, M.; Zhou, S.; Weitz, D. A. 25th Anniversary Article: Double Emulsion Templated Solid Microcapsules: Mechanics And Controlled Release. Adv. Mater. 2014, 26 (14), 2205-2218. https://doi.org/10.1002/adma.201305119.

1. A method of forming a component having a wettability pattern, comprising:
providing a substrate having present thereon a pattern of hydrophobic and hydrophilic regions;
contacting a polymerizable composition to the substrate so as to confer the pattern of hydrophobic and hydrophilic regions onto the polymerizable composition; and
polymerizing the polymerizable composition.

2. The method of claim 1, wherein the substrate comprises silicon.

3. The method of claim 1, wherein the pattern of hydrophobic and hydrophilic regions comprises a silane.

4. The method of claim 1, wherein the polymerizable composition comprises a first component that is comparatively hydrophobic relative to a second component of the composition.

5. The method of claim 4, wherein the contacting gives rise to a region of the polymerizable composition that is comparatively rich in the first component relative to the second component.

6. The method of claim 1, wherein the polymerizable composition comprises a perfluoropolyether (PFPE).

7. The method of claim 1, wherein the polymerizable composition comprises polyethylene glycol diacrylate (PEGDA).

8. A component, the component made according to claim 1.

9. A microfluidic device, comprising:
a polymeric substrate having disposed thereon a pattern of hydrophobic and hydrophilic regions,
the polymeric substrate comprising a first component that is comparatively hydrophobic relative to a second component of the polymeric substrate,
and a hydrophobic region of the polymeric substrate being comparatively rich in the first component relative to the second component.

10. A method, the method comprising using a microfluidic device according to claim 9 to form an emulsion.

11. The method of claim 10, wherein the emulsion is a double emulsion.

12. The method of claim 11, wherein the double emulsion is a water-in-oil-in-water emulsion.

13. The method of claim 11, wherein the double emulsion is an oil-in-water-in-oil emulsion.

14. The method of claim 10, wherein the emulsion is a triple emulsion.

15. A method, the method comprising using a microfluidic device according to claim 9 to invert an emulsion.

16. The method of claim 15, wherein the emulsion comprises a hydrophobic phase within a hydrophilic phase.

17. The method of claim 15, wherein the emulsion comprises a hydrophilic phase within a hydrophobic phase.

18. The method of claim 15, wherein the method is performed so as to separate a multiphase sample.

19. The method of claim 15, wherein the method is performed so as to effect cell patterning.

20. The method of claim 15, wherein the method is performed so as to redirect a fluid flow.
